(19) United States
(12) Patent Application Publication
(10) Pub. No.: US 2015/0159422 A1
(43) Pub. Date: Jun. 11, 2015

(54) WINDOW FRAME WRAPPING SYSTEM

(71) Applicant: 3M INNOVATIVE PROPERTIES COMPANY, St. Paul, MN (US)

(72) Inventor: William C. Pettit, III, St. Paul, MN (US)

(21) Appl. No.: 14/362,496

(22) PCT Filed: Dec. 4, 2012
(86) PCT No.: PCT/US2012/067693

§ 371 Date: Jun. 3, 2014

Related U.S. Application Data
(60) Provisional application No. 61/568,693, filed on Dec. 9, 2011.

(51) Int. Cl. E06B 3/263; E04C 2/24; E04C 2/20; E04B 1/66; E04B 1/76

(52) U.S. Cl. CPC E06B 3/2632; E04B 1/66; E04B 1/7608; E04C 2/20; E04C 2/24; E06B 2003/26332

(57) ABSTRACT

Insulated window assemblies include a window frame, a glazing within the window frame, and a flexible substrate attached to the window frame such that the flexible substrate completely envelopes the window frame. The flexible substrate insulates the window frame from conduction/convection radiation from the outside such that the U value for a window assembly with the flexible substrate is less than for an identical window assembly without the flexible substrate. The flexible substrate is capable of bending at least 90 without breaking. The flexible substrate can include a multi-layer film, including three layers: an adhesive layer; a thermally non-conductive layer; and a continuous film layer. The thermally non-conductive layer can be a foam layer, a porous solid layer, a polymer matrix with hollow spheres or beads, a web, or an air gap between the window film surface and the continuous film layer.

### FIELD OF THE DISCLOSURE

This disclosure relates generally to wrapping systems for window frames.

### BACKGROUND

As energy usage becomes a larger and larger concern, a variety of methods are being explored to make buildings more energy efficient and thereby reduce the energy consumed for heating and cooling. Much of the energy loss for buildings occurs at windows. There are in general 2 direct methods of energy transfer through a window, and 2 indirect methods of energy transfer through a window. The 2 direct methods are 1) solar radiation and 2) convection/conduction of heat. The two indirect methods are 3) visible light transmission and 4) air infiltration. Window films can improve the energy efficiency of a window by effecting (1) solar radiation, and to a small extent (2) the conduction convection component of the glass, however, they do not address the energy that is lost through the window frame.

Several techniques and devices have been developed to provide thermal insulation to windows, doors and window frames. U.S. Pat. No. 3,996,989 (Wall) describes an insulating apparatus for fitting over the inside frames and glass of glass doors and windows. The apparatus includes a polystyrene frame fitted over the inside window or door frame and is removably held in place by fastening means. Sheet vinyl material is stretched over the polystyrene frame and held in position above the glass. U.S. Pat. No. 4,399,640 (Porter) describes a snap-on insulation barrier for window frames that includes a three piece support member, the support member includes: A) a base member attached to the window frame or a wall and having a pair of opposed rails; B) an elongated strip having a C-shaped cross section with inturned ends to engage the rails of A, and an upstanding bead; and C) an elongated strip with an expandable slot formed by flexible opposed rails to snap fit over the upstanding bead of B, and a substantially flat outside surface and a layer of pressure sensitive adhesive for securing a sheet of plastic material. PCT Publication WO 2008/132530 (Tveit), describes an insulating profile for attachment to a window frame such that the surface of the window frame facing the indoor side is covered by the insulating profile that is attached to the window frame. The insulating profile includes a layer of heat insulation material and a surface layer covering at least a part of the surface of the insulation material.

### SUMMARY

Disclosed herein are window assemblies and methods for preparing window assemblies. These window assemblies include a flexible substrate attached to the window frame to provide an insulating effect and are aesthetically pleasing.

In some embodiments, the window assembly comprises a window frame, a glazing within the window frame, and a flexible substrate attached to the window frame such that the flexible substrate completely envelopes the window frame. The flexible substrate insulates the window frame from conduction/convection radiation from the outside such that the U value for a window assembly where the flexible substrate is present is less than for an identical window assembly without the flexible substrate. The flexible substrate is capable of bending at least 90° without breaking.

In some embodiments, the flexible substrate comprises a multi-layer film, including three layers: an adhesive layer; a thermally non-conductive layer; and a continuous film layer. In some embodiments, the thermally non-conductive layer comprises a foam layer, a porous solid layer, a polymer matrix with hollow spheres or beads, or a web. In other embodiments, the thermally non-conductive layer comprises an air gap between the window film surface and the continuous film layer.

Also disclosed are methods for preparing an insulated window frame. In some embodiments, the method comprises providing a window, where the window comprises a window frame and a glazing within the window frame, providing a flexible substrate, and attaching the flexible substrate to the window frame such that the flexible substrate completely envelopes the window frame.

### BRIEF DESCRIPTION OF THE DRAWINGS

The present application may be more completely understood in consideration of the following detailed description of various embodiments of the disclosure in connection with the accompanying drawings.

FIG. 1 shows a cross sectional view of an embodiment of a background window assembly.

FIG. 2 shows a cross sectional view of an embodiment of a window assembly of this disclosure.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

A large source of energy loss for heating and cooling of buildings is loss through windows. There are in general 2 direct methods of energy transfer through a window, and 2 indirect methods of energy transfer through a window. The 2 direct methods are 1) solar radiation and 2) convection/conduction of heat. The two indirect methods are 3) visible light transmission and 4) air infiltration. A wide array of different techniques has been employed to reduce the energy loss through windows. One method for reducing energy loss, is to replace the windows with newer, more efficient windows. However replacement of windows is not only prohibitively expensive and inconvenient, it also generates large quantities of waste. Therefore, techniques that involve retrofitting existing windows to improve their efficiency are desirable and much in demand. For example, a variety of window films have been developed that can improve the energy efficiency of a window by effecting (1) solar radiation, and to a small extent (2) the conduction convection component of the glass. However, these window films do not address the energy that is lost through the window frame. This is particularly true for aluminum window frames, a type of window frame that is especially common in the windows of commercial buildings. Metal frames, especially aluminum window frames have high rates of thermal conductivity and therefore are not good choices for energy efficient window frames. However, because they provide good structural support they have often been used in the past and continue to be used.

Therefore, methods of retrofitting window frames to insulate them and reduce energy loss from the window frame are desirable. The present disclosure includes methods for preparing insulated window assemblies. These window assemblies include a window frame, a glazing within the window frame, and a flexible substrate attached to the window frame such that the flexible substrate completely envelopes the window frame. This flexible substrate not only provides thermal insulation to the window frame, it also can provide electrical insulation of the window frame and is aesthetically pleasing. Because the insulating substrate is flexible, it is easily installed on the window frame and is adaptable to a wide range of window frames, unlike rigid insulation substrates that need to be specially made or adapted for each window frame.

The term “adhesive” as used herein refers to polymeric compositions useful to adhere together two adherends. Examples of adhesives are heat activated adhesives, and pressure sensitive adhesives.

Heat activated adhesives are non-tacky at room temperature but become tacky and capable of bonding to a substrate at elevated temperatures. These adhesives usually have a Tg or melting point (Tm) above room temperature. When the temperature is elevated above the Tg or Tm, the storage modulus usually decreases and the adhesive become tacky. Pressure sensitive adhesive (PSA) compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. Obtaining the proper balance of properties is not a simple process.

The term “(meth)acrylate” as used herein, refers to both acrylates and methacrylates. Acrylates are esters of acrylic acid, and methacrylates are esters of methacrylic acid.

Disclosed herein are window assemblies that comprise a window frame, a glazing within the window frame, and a flexible substrate attached to the window frame such that the flexible substrate completely envelopes the window frame.

A wide variety of window frames are suitable for use in the window assemblies of this disclosure. Typically, window frames are made of wood, plastic or metal. While wooden and plastic frames are often used for the windows in homes, metal frames, especially aluminum frames are often used in commercially buildings.

The frame is used to hold a glazing. Typically, the glazing is selected from one of a wide array of different types of glass, but the glazing may also be made of a transparent plastic plate. Examples of transparent plastic plates include polycarbonate (PC) plates and poly(meth)acrylate plates such as, for example, polymethylmethacrylate (PMMA) plates. The glazing may be a single layer, but often the glazing comprises multiple layers, such as the so-called “double pane” (comprising two layers of glazing) or “triple pane” (comprising three layers of glazing) windows. The multiple layers may be in contact with each other, they may have intervening layers, or they may be separated by a void space. The intervening layers may be film layers (such as shatter resistant films or solar control films) or coatings such as adhesive layers. In some embodiments that contain a void space, the void space may contain air or another gas (such as nitrogen or argon) or the void space may be a vacuum.

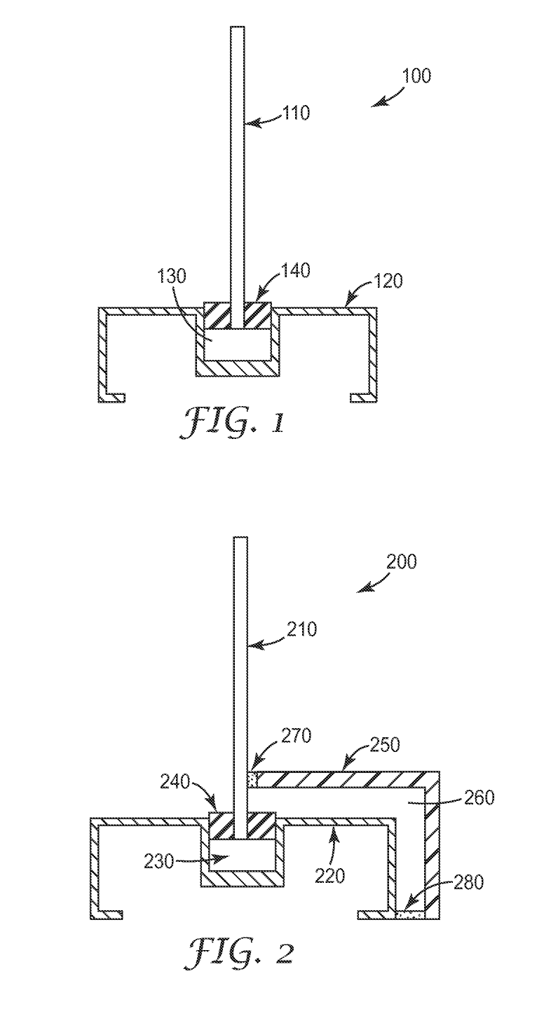

An example of a typical window assembly is shown in FIG. 1. FIG. 1 shows window assembly 100 with glazing 110 and frame 120. Glazing 110 is held in frame 120 by seal 140, and air space 130. Seal 140 may encompass air space 130, but typically air space 130 is present as an air gap within the window assembly. Typically the seal 140 is prepared from a rubbery material such as polyisobutylene. If a gap is present in the seal 140, or if a gap forms over time, a pathway for air to flow through the window frame is provided.

The window assemblies of the present disclosure also include a flexible substrate that completely envelopes the window frame. By “completely envelopes” it is meant that all exposed portions of the window frame that are to be covered by the flexible substrate are covered by the flexible substrate. An example of a window assembly of this disclosure is shown in FIG. 2. FIG. 2 depicts window assembly 200 with glazing 210 and frame 220. Glazing 210 is held in frame 220 by seal 240, and air space 230. Seal 240 may encompass air space 230, but typically air space 230 is present as an air gap within the window assembly. Window assembly 200 also comprises a flexible substrate comprising layers 250 and 260. Layer 250 comprises a flexible film layer that is described in greater detail below. Layer 260 comprises a thermally non-conductive layer. This thermally non-conductive layer may be a physical layer such as a foam layer, a porous solid layer, polymer matrices with hollow spheres or beads, a web, or a similar layer, or layer 260 may be a layer of air trapped between the frame 220 and flexible film layer 250. Each of these possibilities will be discussed in greater detail below. If layer 260 is a physical layer, it may be attached to the frame 220 by a continuous or discontinuous layer of adhesive (not shown). Additionally, the flexible film layer 260 can be adhered to the frame 220 and/or the glazing 210 by sealing member 270. Sealing member 270 may be a layer of adhesive, a double-sided tape, a single-sided tape, or a sealant. Examples of suitable sealants include caulks, glues, and other similar types of sealants. Sealing member 270 may be only attached to the edge surface of layer 250 as shown in FIG. 2 or it may encompass the edge surface of layer 260. Additionally, sealing member 270 may be non-adhesive edge seal for layer 260 and/or layer 250 and therefore merely abutted to glazing 210 instead of adhered to glazing 210. Layer 260 is capped by sealing member 280. Sealing member 280 may be a layer of adhesive, a tape, or a sealant. Suitable sealants include caulks, glues, or other similar types of sealants. In some embodiments, the window assembly further comprises a wall or ceiling (not shown). In some embodiments, the flexible substrate can be attached to a portion of the glazing, a portion of the wall or ceiling, or both. In some embodiments, the window frame comprises a first major surface and a second major surface. In FIG. 2, the first major surface is the surface to which the flexible substrate is attached, and faces the inside of building and the second major surface faces the outside environment.

The flexible substrate insulates the window frame from conduction/convection radiation from the outside such that the U value for a window assembly where the flexible substrate is present is less than for an identical window assembly without the flexible substrate. An example of window assembly where the flexible substrate is present is shown in FIG. 2, and an example of an identical window assembly without the flexible substrate is shown in FIG. 1.

The U value or U-factor is the overall heat transfer coefficient and describes how well a building element conducts heat. It measures the rate of heat transfer through a building element over a given area, under standardized conditions. The usual standard is at a temperature gradient of 24° C., at 50% relative humidity with no wind (a smaller U-value means that an element is a better insulator). U values are well understood in the art.

In some embodiments, the window assembly also provides electrical insulation for the window frame. As window films and window constructions are being developed that can generate electricity, it becomes increasing important that the window frame be electrically insulated to protect users from the generated electricity. This is especially true for window frames that are electrically conductive, such as metal frames. The insulating constructions of this disclosure provide not only thermal insulation but also electrical insulation.

A variety of different flexible substrates are possible for use in the window assemblies of this disclosure. As described above, in some embodiments, the flexible substrate can comprise a multi-layer substrate. In some embodiments, the flexible substrate comprises three layers: a continuous or discontinuous adhesive layer to adhere the flexible substrate to the frame; a thermally non-conductive layer; and a flexible film layer.

The adhesive layer may be a continuous or discontinuous layer, as desired. The adhesive may be a pressure sensitive adhesive or a heat activated adhesive. Typically, the adhesive is a pressure sensitive adhesive. Suitable pressure sensitive adhesives include those based on natural rubbers, synthetic rubbers, styrene block copolymers, polyvinyl ethers, acrylics, poly-α-olefins, silicones, urethanes or ureas.

The thermally non-conductive layer is discontinuous to form an insulating layer. The thermally non-conducting layer comprises a foam layer, a porous solid layer, polymer matrices with hollow spheres or beads, a web, or other similar layer. Examples of suitable foam layers include both open cell and closed cell foams. The foam may be prepared from a wide variety of materials including polyurethane, polystyrene, polyolefins, polyesters, and combinations thereof. Examples of porous solids include polyurethane sheets, polystyrene sheets (under the trade name STYROFOAM), and cork board. Examples of polymer matrices with hollow spheres or beads include the insulating structural members described in US Patent Publication No. 2011/0265408 (Jha et al.) which include polyamide-poly(arylene ether) matrices with 5-45 weight % of hollow glass beads. Examples of webs include a wide variety of non-woven webs and batts prepared from fiberglass, rock wool, and a wide range of man-made and natural fibers such as described in U.S. Pat. No. 5,620,541 (Herzberg) and may include polyethylene terephthalate, polyamide, wool, polyvinyl chloride, (meth)acrylate, polyolefins such as polyethylene, and polypropylene and combinations thereof. Typically the thermally non-conducting layer has a thickness of from about 6.35 millimeters (0.25 inch) to about 25.4 millimeters (1 inch).

A wide variety of materials may be used to form the flexible film layer. The flexible film layer is a continuous film layer and may comprise a single film layer or be a multi-layer film construction. Examples of suitable film materials include vinyl films, such as decorative vinyl films, (meth)acrylate films, polycarbonate films, polyester films, such as polyethylene terephthalate (PET) or combinations thereof. It is desirable that this continuous film layer be flexible so that the entire substrate is flexible. In some embodiments, it is desirable that a decorative pattern be present on the exterior surface of the flexible film layer. For example, if the flexible substrate is used with a wooden frame, the film can have wood grain pattern to give the appearance of wood. If the flexible substrate is used with a metal frame, the film can be colored to give the appearance of metal. Additionally, virtually any color or pattern can be printed on the film to give the desired appearance. Generally, the flexible film layer is capable of bending through at least 90° without breaking. In some embodiments, the flexible film layer is capable of bending through at least 180° without breaking.

In some embodiments, the only physical layer is a flexible continuous film layer. When this type of flexible substrate is used in the window assembly, an air gap is typically present between the frame and the continuous film layer. Examples of suitable flexible continuous film layers include those described above. The air layer can be formed by attaching the continuous film layer to the glazing and to the frame with sealing members as shown in FIG. 2. The sealing members may independently comprise a layer of adhesive, a tape, or a sealant. Examples of suitable sealants include caulks, glues, and other similar types of sealants. The sealant, if used, is typically a curable sealant that is applied as a viscous fluid and cured in place to form a seal. The sealants may cure by drying (for example, casein glues), by reaction with water (for example, moisture curing silicone sealants), or may be a two part reactive system that cures upon mixing (for example, two part urethane sealants). In some embodiments, it may be desirable for the sealing members to comprise an adhesive layer or a tape. In this way the sealing members do not require curing or the handling of fluid sealants. In some embodiments, the sealing member 270 comprises a layer of pressure sensitive adhesive or a double-sided tape. A double-sided tape, sometimes called a transfer tape, is a free standing tape that has adhesive layers on both exposed surfaces of the tape and may comprise internal layers of, for example, film. The double-sided tape may comprise a foamed tape, meaning that the tape has a foam layer in the middle of the tape. Examples of suitable double-sided foam tapes include those sold by 3M Company, St. Paul, Minn. under the trade name “VHB TAPE”. An example of such a tape is 3M VHB TAPE 4941 commercially available from 3M Company, St. Paul, Minn. In some embodiments, the sealing member 280 comprises a tape. Typically the tape is a single-sided tape, meaning that it comprises an adhesive layer and a backing. The backing may be a multi-layer backing or it may comprise a foam layer. Examples of suitable double-sided foam tape include those sold by 3M Company, St. Paul, Minn. under the trade name “VHB TAPE”. Examples of such a tapes are 3M VHB TAPE 4611, 3M VHB TAPE 4618, 3M VHB TAPE 4622, 3M VHB TAPE 4905, 3M Company, St. Paul, Minn.

The flexible substrate is designed to be flexible to permit the flexible substrate to completely envelope the window frame. The continuous film layer is flexible, as described above. Additional layers, if present, are also flexible, such that the entire flexible substrate is capable of bending through at least 90° without breaking. In some embodiments, the flexible substrate is capable of bending through at least 180° without breaking.

Also disclosed are methods for preparing an insulated window frame comprising providing a window, where the window includes a window frame and a glazing within the window frame, providing a flexible substrate, and attaching the flexible substrate to the window frame such that the flexible substrate completely envelopes the window frame. By “completely envelopes” it is meant that all exposed portions of the window frame that are to be covered by the flexible substrate are covered by the flexible substrate. The formed insulated window frame comprises the window assemblies described above.

The flexible substrate is attached to the window frame through a continuous or discontinuous adhesive layer on the flexible substrate or by at least two sealing members. In some embodiments, the flexible substrate comprises a multi-layer film. The multi-layer film may comprise a three layer film: a continuous or discontinuous adhesive layer; a thermally non-conductive layer; and a continuous film layer. Each of these layers has been described above. In other embodiments, the flexible substrate comprises a flexible continuous film attached to the window frame such that an air gap is present between the window frame surface and the film substrate. In these embodiments, the film substrate can be attached to the frame surface through a pair of sealing members as shown in FIG. 2. Suitable sealing members are described above.

As described above, the application of the flexible substrate to the window fame provides an insulating effect for the window frame. In some embodiments, the flexible substrate insulates the window frame from conduction/convection radiation with the outside such that the U value for a window assembly wherein the flexible substrate is present is less than for an identical window assembly without the flexible substrate. In some embodiments, the flexible substrate electrically insulates the window frame.

Different suitable embodiments of the flexible substrate are described above and include a multi-layer film and a flexible continuous film with an air gap between the frame and the film. Techniques for attaching the flexible substrate to the frame may be different for each of these different embodiments of flexible substrate.

For example, attachment of a multi-layer film flexible substrate may involve simply contacting the continuous or discontinuous adhesive layer of the multi-layer film to the frame surface to form the attachment. Similarly, the sealing members, if present on the flexible substrate, can be contacted to the frame surface and/or the surface of the glazing or a wall or ceiling if desired. In some embodiments, the sealing members are not present on the flexible substrate. In these embodiments, the sealing members can be applied to the frame surface prior to the attachment of the flexible substrate, or can be applied to the flexible substrate/window frame construction after attachment of the flexible substrate. For example, if sealing member 270 is a sealant, it may be applied after the attachment of the flexible substrate to seal the space between the flexible substrate and the frame and/or the glazing.

Typically, in embodiments that include an air gap between the frame and the film substrate, one end of the film substrate is attached to the frame, for example by sealing member 270, a pocket of air is trapped beneath the film substrate, and the second sealing member is then attached. In some embodiments, additional sealing members may be present to prevent the escape of air from the air gap. Additionally, it may be desirable to direct a stream of air or other gas into the air gap as the film substrate is attached to the second sealing member to help keep the film substrate apart from the frame surface.

Depending upon the nature and location of the window frame, it may be desirable to additionally attach the flexible substrate to a portion of the glazing of the window and/or to surfaces adjacent to the window frame such as a ceiling or wall. Attachment to the glazing and/or wall or ceiling can help the insulating effect of the flexible substrate by eliminating pathways for exterior air to pass through the frame.

Typically the flexible substrate is applied to the side of the window frame that is inside a building. This means that the window frame comprises a first major surface and a second major surface, and the first major surface faces the inside of building and the second major surface faces the outside environment, and thus the flexible substrate is attached to first major surface of the window frame.

The present disclosure includes the following embodiments.

Among the embodiments are window assemblies. A first embodiment includes a window assembly comprising: a window frame; a glazing within the window frame; and a flexible substrate attached to the window frame such that the flexible substrate completely envelopes the window frame.

Embodiment 2 is the window assembly of embodiment 1, wherein the flexible substrate insulates the window frame from conduction/convection radiation from the outside such that the U value for a window assembly wherein the flexible substrate is present is less than for an identical window assembly without the flexible substrate.

Embodiment 3 is the window assembly of embodiment 1 or 2, wherein the flexible substrate electrically insulates the window frame.

Embodiment 4 is the window assembly of any of embodiments 1-3, wherein the flexible substrate is capable of bending at least 90° without breaking.

Embodiment 5 is the window assembly of any of embodiments 1-3, wherein the flexible substrate is capable of bending at least 180° without breaking.

Embodiment 6 is the window assembly of any of embodiments 1-5, wherein the flexible substrate comprises a multi-layer film.

Embodiment 7 is the window assembly of embodiment 6, wherein the multi-layer film comprises a three layer film, comprising an adhesive layer, a thermally non-conductive layer, and a continuous film layer.

Embodiment 8 is the window assembly of embodiment 7, wherein the continuous film layer comprises a vinyl film, a (meth)acrylate film, a polycarbonate film, or a polyester film.

Embodiment 9 is the window assembly of embodiment 7 or 8, wherein the non-conducting layer comprises a foam layer, a porous solid layer, a polymer matrix with hollow spheres or beads, or a web.

Embodiment 10 is the window assembly of any of embodiments 1-5, wherein the flexible substrate comprises a film attached to the window frame such that an air gap is present between the window frame surface and the film.

Embodiment 11 is the window assembly of embodiment 10, wherein the film substrate comprises a vinyl film, a (meth)acrylate film, a polycarbonate film, or a polyester film.

Embodiment 12 is the window assembly of embodiment 10 or 11, wherein the flexible substrate is attached to the window frame by at least two sealing members, the sealing members independently comprising an adhesive layer, a tape, or a sealant.

Embodiment 13 is the window assembly of any of embodiments 1-12, further comprising a wall or ceiling adjacent to the window frame, and wherein the flexible substrate is attached to a portion of the glazing, a portion of the wall or ceiling, or both.

Embodiment 14 is the window assembly of any of embodiments 1-13, wherein the window frame comprises a first major surface and a second major surface, and wherein the first major surface faces the inside of building and the second major surface faces the outside environment, and wherein the flexible substrate is attached to first major surface of the window frame.

Among the embodiments are methods for preparing insulated window frames. Embodiment 15 is a method for preparing an insulated window frame comprising: providing a window comprising a window frame and a glazing within the window frame; providing a flexible substrate; and attaching the flexible substrate to the window frame such that the flexible substrate completely envelopes the window frame.

Embodiment 16 is the method of embodiment 15, wherein attaching the flexible substrate to the window frame comprises adhering through a continuous or discontinuous adhesive layer on the flexible substrate and/or by at least two sealing members.

Embodiment 17 is the method of embodiment 15 or 16, wherein the flexible substrate insulates the window frame from conduction/convection radiation with the outside such that the U value for a window assembly wherein the flexible substrate is present is less than for an identical window assembly without the flexible substrate.

Embodiment 18 is the method of any of embodiments 15-17, wherein the flexible substrate electrically insulates the window frame.

Embodiment 19 is the method of any of embodiments 15-18, wherein the flexible substrate is capable of bending at least 90° without breaking.

Embodiment 20 is the method of any of embodiments 15-18, wherein the flexible substrate is capable of bending at least 180° without breaking.

Embodiment 21 is the method of any of embodiments 15-20, wherein the flexible substrate comprises a multi-layer film, a polycarbonate film, or a polyester film.

Embodiment 27 is the method of any of embodiments 15-26, further comprising a wall or ceiling adjacent to the window frame, and wherein the flexible substrate is attached to a portion of the glazing, a portion of the wall or ceiling, or both.

Embodiment 28 is the method of any of embodiments 15-27, wherein the window frame comprises a first major surface and a second major surface, and wherein the first major surface faces the inside of building and the second major surface faces the outside environment, and wherein the flexible substrate is attached to first major surface of the window frame.

### EXAMPLES

The window frame assemblies shown in FIGS. 1 and 2 were modeled to determine the U value with and without the insulating flexible substrate of this disclosure. The modeling assumed a 0.32 centimeter (⅛ inch) thick aluminum frame window assembly and was done using the THERM program (free program available from Lawrence Berkeley National Laboratories) with boundary conditions: all left facing exterior edges were NFRC (National Fenestration Rating Council) 100-2001 Exterior, the interior right facing edges were chosen to be polycarbonate, the black edges are adiabatic, and the red are frame cavity. The model assumed an air gap present between the frame and the continuous film layer. The gaskets sealing the window were modeled using polyisobutylene. The simulation assumed a 0.32 centimeter (⅛ inch) thick single pane fixed picture window (120 centimeter (47.2 inch) width×150 centimeter (59.1 inch) height) with the aluminum frame. Output of the THERM program was exported into the Window 5 program, which is the industry standard method for calculating whole window U values. The window assembly without flexible substrate (FIG. 1) had a U value of 0.863 vs. 0.833 for the same window assembly with the insulating flexible substrate of this disclosure enveloping the window frame (FIG. 2).

What is claimed is:

1. A window assembly comprising:
a window frame;
a glazing within the window frame; and
a flexible substrate attached to the window frame such that the flexible substrate completely envelopes the window frame.

2. The window assembly of clam 1, wherein the flexible substrate insulates the window frame from conduction/convection radiation from the outside such that the U value for a window assembly wherein the flexible substrate is present is less than for an identical window assembly without the flexible substrate.

3. The window assembly of clam 1, wherein the flexible substrate is capable of bending at least 90° without breaking.

4. The window assembly of claim 1, wherein the flexible substrate comprises a multi-layer film.

5. The window assembly of claim 4, wherein the multi-layer film comprises a three layer film, comprising an adhesive layer, a thermally non-conductive layer, and a continuous film layer.

6. The window assembly of claim 5, wherein the continuous film layer comprises a vinyl film, a (meth)acrylate film, a polycarbonate film, or a polyester film.

7. The window assembly of claim 5, wherein the non-conducting layer comprises a foam layer, a porous solid layer, a polymer matrix with hollow spheres or beads, or a web.

8. The window assembly of clam 1, wherein the flexible substrate comprises a film attached to the window frame such that an air gap is present between the window frame surface and the film.

9. The window assembly of claim 8, wherein the flexible substrate is attached to the window frame by at least two sealing members, the sealing members independently comprising an adhesive layer, a tape, or a sealant.

10. The window assembly of claim 1, further comprising a wall or ceiling adjacent to the window frame, and wherein the flexible substrate is attached to a portion of the glazing, a portion of the wall or ceiling, or both.

11. A method for preparing an insulated window frame comprising:
providing a window construction comprising a window frame and a glazing within the window frame;
providing a flexible substrate; and
attaching the flexible substrate to the window frame such that the flexible substrate completely envelopes the window frame.

12. The method of claim 11, wherein attaching the flexible substrate to the window frame comprises adhering through a continuous or discontinuous adhesive layer on the flexible substrate and/or by at least two sealing members.

13. The method of claim 11, wherein the flexible substrate insulates the window frame from conduction/convection radiation with the outside such that the U value for a window assembly wherein the flexible substrate is present is less than for an identical window assembly without the flexible substrate.

14. The method of clam 11, wherein the flexible substrate is capable of bending at least 90° without breaking.

15. The method of claim 11, wherein the flexible substrate comprises a multi-layer film.

16. The method of claim 15, wherein the multi-layer film comprises a three layer film, comprising an adhesive layer, a thermally non-conductive layer, and a continuous film layer.

17. The method of claim 16, wherein the continuous film layer comprises a vinyl film, a (meth)acrylate film, a polycarbonate film, or a polyester film.

18. The method of claim 16, wherein the thermally non-conductive layer comprises a foam layer, a porous solid layer, a polymer matrix with hollow spheres or beads, or a web.

19. The method of clam 11, wherein the flexible substrate comprises a film attached to the window frame such that an air gap is present between the window frame surface and the film.

20. The method of claim 11, further comprising a wall or ceiling adjacent to the window frame, and wherein the flexible substrate is attached to a portion of the glazing, a portion of the wall or ceiling, or both.
